(19) United States
(12) Patent Application Publication
(10) Pub. No.: US 2024/0182324 A1
(43) Pub. Date: Jun. 6, 2024

(54) CATHODE MATERIAL CONTAINING BIMETAL-DOPED BARIUM COBALTITE-BASED PEROVSKITE AND BI-DIRECTIONAL PROTON CONDUCTIVE FUEL CELL CONTAINING THE SAME

(71) Applicant: KOREA ADVANCED INSTITUTE OF SCIENCE AND TECHNOLOGY, Daejeon (KR)

(72) Inventors: Kang Taek LEE, Daejeon (KR); Se Eun OH, Daejeon (KR); Dong Yeon KIM, Daejeon (KR)

(21) Appl. No.: 18/521,774

(22) Filed: Nov. 28, 2023

(30) Foreign Application Priority Data
Dec. 1, 2022 (KR) 10-2022-0166153

(51) Int. Cl. C01G 51/00; H01M 8/14

(52) U.S. Cl. CPC C01G 51/66; H01M 8/14; C01P 2002/34; C01P 2002/72; C01P 2004/03; C01P 2004/82; C01P 2006/40

(57) ABSTRACT

A cathode material comprises bimetal-doped barium cobaltite-based perovskite and a bi-directional protonic ceramic fuel cell comprising the same. In a cathode material according to an embodiment, barium cobaltite is doped with scandium (Sc) and tantalum (Ta), and the cathode material is represented by the following Formula 1:

BaScₓTa_{0.2-x}Co_{0.8}O_{3-δ} [Formula 1]
where X is 0.001<X<0.199, δ is 0<δ<2.

### CROSS REFERENCE TO RELATED APPLICATION

The present application claims priority to Korean Patent Application No. 10-2022-0166153, filed Dec. 1, 2022, the entire contents of which is incorporated herein for all purposes by this reference.

### BACKGROUND OF THE INVENTION

### Field of the Invention

The present disclosure relates to a cathode material comprising bimetal-doped barium cobaltite-based perovskite and a bi-directional protonic ceramic fuel cell comprising the same.

### Description of the Related Art

Recently, as energy consumption has increased due to global industrial development and the resulting problem of fossil fuel depletion has emerged, the development of eco-friendly energy conversion devices has been attracting attention. Among them, the bi-directional protonic ceramic fuel cell is a next-generation renewable energy conversion device that can directly convert chemical energy into electrical energy with high efficiency and can replace existing commercialized energy conversion devices.

The bi-directional protonic ceramic fuel cell has the advantage of low activation energy required for ion conduction because it uses protons with a relatively small ionic radius and mass compared to the existing oxygen ion-mediated bi-directional solid oxide fuel cell (SOFC). Accordingly, the bi-directional protonic ceramic fuel cell has high performance and efficiency at low temperatures of less than 600° C., allowing the selection of inexpensive materials, which has the advantage of building a low-cost, high-efficiency system.

The bi-directional protonic ceramic fuel cell includes an anode supplied with hydrogen or hydrocarbon-based fuel, a cathode supplied with oxygen, and a proton conductive electrolyte. In this case, unlike the cathode used in existing solid oxide fuel cells, an oxide with a perovskite structure having triple conductivity (H⁺/O²⁻/e⁻) is used as the cathode, so that the electrically active area can be expanded to the entire surface of the cathode.

Representative oxides with a triple conductive perovskite structure known to date include PrBa_{0.5}Sr_{0.5}Co_{1.5}Fe_{0.5}O_{5+δ}(PBSCF), BaCo_{0.4}Fe_{0.4}Zr_{0.1}Y_{0.1}O_{3-δ}(BCFZY), BaGd_{0.8}La_{0.2}Co₂O_{6-δ}(BGLC), NdBa_{0.5}Sr_{0.5}Co_{1.5}Fe_{0.5}O_{5+δ}(NBSCF), etc. Among them, PBSCF shows excellent electrochemical performance and is used as the cathode of the protonic ceramic fuel cell.

However, in the case of the oxide-based cathode with the strontium-doped perovskite structure as described above, there is a problem that strontium segregation occurs under actual long-term operating conditions, causing performance degradation. Therefore, there is interest in developing a cathode without strontium doping.

For example, an oxide with a barium cobaltite-based perovskite structure can have the advantage of oxygen ion movement within the crystal lattice due to barium's large ionic radius (161 pm) and the ability to easily form proton defects due to low electronegativity. In addition, barium (0.25 USD/kg or less) is less expensive than strontium (6.53 USD/kg or less), so it has advantages in terms of fuel cell manufacturing process and large area.

However, it is difficult to manufacture the bi-directional protonic ceramic fuel cell with high performance due to the still relatively slow oxygen reduction reaction and oxygen generation reaction at the cathode. Recently, as one of the solutions to the above problems, a material with the strontium cobaltite-based perovskite structure doped with a bimetal using a transition metal has been reported to show improved performance as the cathode for the solid oxide fuel cell. Accordingly, there is a need for extensive research and development on this.

### SUMMARY OF THE INVENTION

Therefore, in order to solve the above described conventional problems, an embodiment of the present disclosure has an object to provide a technology of a cathode material comprising bimetal-doped barium cobaltite-based perovskite, which shows excellent long-term stability while exhibiting high electrochemical properties, and a bi-directional protonic ceramic fuel cell comprising the cathode material.

The technical objects to be achieved by the present invention are not limited to the technical objects mentioned above, and other technical objects not mentioned may be clearly understood by those skilled in the art from the following descriptions.

In order to achieve the above objects, an embodiment of the present disclosure provides a cathode material comprising a bimetal-doped barium cobaltite-based perovskite in which barium cobaltite is doped with scandium (Sc) and tantalum (Ta) and which is represented by the following Formula 1:

BaScₓTa_{0.2-x}Co_{0.8}O_{3-δ} [Formula 1]
where X is 0.001<X<0.199, δ is 0<δ<2.

According to an embodiment, in the Formula 1, X may be 0.05≤X≤0.15.

The bimetal-doped barium cobaltite-based perovskite may have a cubic perovskite crystal structure at room temperature.

In addition, an embodiment provides a method for manufacturing a cathode material comprising the steps of mixing a barium precursor, a scandium precursor, a tantalum precursor, and a cobalt precursor respectively and ball milling the mixture to prepare a mixed pulverized product; pelletizing the mixed pulverized product to prepare a green compact; and sintering and pulverizing the green compact to prepare a bimetal-doped barium cobaltite-based perovskite powder in which barium cobaltite is doped with scandium (Sc) and tantalum (Ta) and which is represented by the following Formula 1:

BaScₓTa_{0.2-x}Co_{0.8}O_{3-δ} [Formula 1]
where X is 0.001<X<0.199, δ is 0<δ<2.

According to an embodiment, in the step of preparing the bimetal-doped barium cobaltite-based perovskite powder, the mixed pulverized product is sintered at a temperature of 1,000 to 1,500° C.

In addition, an embodiment provides A bi-directional protonic ceramic fuel cell, comprising a cathode prepared by the cathode material described above; a proton conductive electrolyte layer located on the cathode; and an anode located on the proton conductive electrolyte layer.

The bi-directional protonic ceramic fuel cell may have a power density of 0.27 to 1.97 W/cm² in fuel cell mode at 450 to 650° C., and a power density of 0.12 to 2.69 A/cm² in electrolytic cell mode at 450 to 650° C.

In addition, in the bi-directional protonic ceramic fuel cell, a performance of the cathode may not change for more than 100 hours in fuel cell mode at 550° C. and for more than 300 hours in electrolytic cell mode at 550° C.

### BRIEF DESCRIPTION OF THE DRAWINGS

FIG. 1 is a process diagram showing a method for manufacturing a cathode material according to Example.

FIG. 2 shows the result of analyzing an X-ray diffraction pattern to analyze the crystal structure of perovskite powders (BSTC05, BSTC10, BSTC15) prepared by a method according to Example.

FIG. 3 is an SEM image showing a microstructure of a cell with anode-supported bi-directional proton conduction unit, which comprises a cathode using a perovskite powder (BSTC10) manufactured by a method according to Example.

FIG. 4 shows the result of analyzing an electrode resistance of a cell with anode-supported bi-directional proton conductive unit, which comprises a cathode using a perovskite powder (BSTC05, BSTC10, BSTC15) manufactured by a method according to Example.

FIG. 5 shows the result of evaluating a performance in (a) fuel cell mode and (b) electrolytic cell mode of a cell with anode-supported bi-directional proton conductive unit, which comprises a cathode using a perovskite powder (BSTC10) manufactured by a method according to Example.

FIG. 6 shows the result of evaluating a long-term stability in fuel cell mode of a cell with anode-supported bi-directional proton conductive unit, which comprises a cathode using a perovskite powder (BSTC10) manufactured by a method according to Example.

FIG. 7 shows the result of evaluating a long-term stability in electrolytic cell mode of a cell with anode-supported bidirectional proton conductive unit, which comprises a cathode using perovskite powder (BSTC10) manufactured by a method according to Example.

### DETAILED DESCRIPTION OF THE INVENTION

Hereinafter, exemplary embodiments of the present invention will be described in detail with reference to accompanying drawings. However, it should be understood that the present invention can be implemented in various forms, and that it is not intended to limit the present invention to the exemplary embodiments. Also, in the drawings, descriptions of parts unrelated to the detailed description are omitted to clearly describe the present invention. Throughout the specification, like numbers refer to like elements.

Throughout this specification, when a part is mentioned as being “connected (accessed, contacted, coupled)” to another part, this means that the part may not only be “directly connected” to the other part but may also be “indirectly connected” to the other part through another member interposed therebetween. In addition, when a part is mentioned as “including” a specific component, this does not preclude the possibility of the presence of other component(s) in the part which means that the part may further include the other component(s), unless otherwise stated.

The terminology used herein is for the purpose of describing various embodiments only and is not intended to limit the present invention. The singular forms are intended to include the plural forms as well, unless the context clearly indicates otherwise. It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

Hereinafter, embodiments of the present invention will be described in detail with reference to the attached drawings.

The cathode material according to an embodiment may include a bimetal-doped barium cobaltite-based perovskite compound in which barium cobaltite is doped with scandium (Sc) and tantalum (Ta) and which is represented by the following Formula 1.

BaScₓTa_{0.2-x}Co_{0.8}O_{3-δ} [Formula 1]

The cathode material as described above is barium cobaltite doped with a bimetal including scandium (Sc) and tantalum (Ta), and may have a cubic perovskite crystal structure at room temperature. Accordingly, it is possible to form a cathode with greatly improved electrical properties and long-term stability.

In order to exhibit the above characteristics, in Formula 1, X may be 0.001<X<0.199, and δ may be 0<δ<2. If the X value is 0.001 or less, because the doping amount of scandium (Sc) is small, it is difficult to expect improvement in physical properties. If the X value is 0.2 or greater, tantalum (Ta) is not doped, so it is difficult to expect a synergy effect from bimetal doping.

In particular, in Formula 1, X may be 0.05≤X≤0.15, and δ may be 0<δ≤0.6.

Preferably, the bimetal-doped barium cobaltite-based perovskite compound may be a compound doped with equal amounts of scandium (Sc) and tantalum (Ta). Accordingly, this compound can form a cathode with excellent electrical properties and long-term stability. That is, X may be 0.1.

The cathode material may be a cathode material for manufacturing a bi-directional protonic ceramic fuel cell.

The doping of the bimetal may be performed through a process of artificially implanting a dopant, such as diffusion or ion implantation, but the process is not limited thereto.

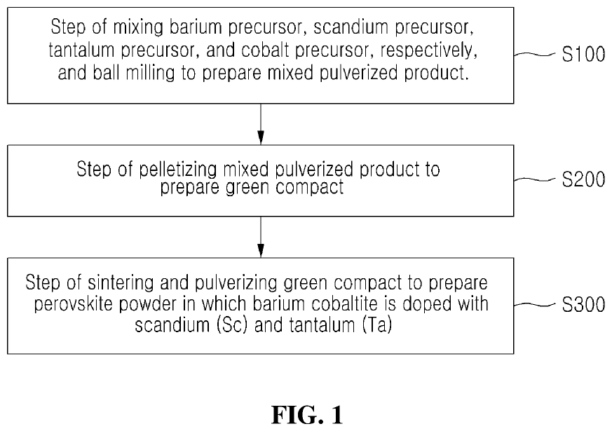

Meanwhile, FIG. 1 is a process diagram showing a method for manufacturing a cathode material according to Example.

Referring to FIG. 1, a method for manufacturing a cathode material according to an embodiment may be a solid state reaction method including the steps of preparing a mixed pulverized product (S100); preparing a green compact (S200); and preparing a bimetal-doped barium cobaltite-based perovskite powder (S300).

In the step of preparing the mixed pulverized product (S100), a barium precursor, a scandium precursor, a tantalum precursor, and a cobalt precursor can be mixed, respectively, and ball milled to prepare the mixed pulverized product.

The barium precursor, scandium precursor, tantalum precursor, and cobalt precursor may each be of various types commonly used for producing perovskite compounds.

For example, the barium precursor may be barium carbonate (BaCO₃), the scandium precursor may be scandium oxide (Sc₂O₃), the tantalum precursor may be tantalum oxide (Ta₂O₅), and the cobalt precursor may be cobalt oxide (Co₃O₄).

In this step, the barium precursor, the scandium precursor, the tantalum precursor, and the cobalt precursor are each mixed in a stoichiometric ratio, the mixed powder is mixed with ethanol, and then ball milled using a zirconia ball, etc. to prepare a mixed pulverized product.

Next, in the step of preparing the green compact (S200), the mixed pulverized product can be pelletized to produce the green compact. Through this process, the mixed pulverized product is pressed to promote the reaction of each precursor, thereby preparing a powder with uniform physical properties.

This step can be performed using various types of conventional pelletizing apparatuses used to pressurize the mixed pulverized product and form the pressurized material into the green compact.

Next, in the step (S300) of preparing a bimetal-doped barium cobaltite-based perovskite, the green compact is sintered and pulverized to dope the barium cobaltite with scandium (Sc) and tantalum (Ta), thereby preparing the bimetal-doped barium cobaltite-based perovskite powder in which barium cobaltite is doped with scandium (Sc) and tantalum (Ta) and which is represented by the following Formula 1.

In this step, the green compact may be sintered at a temperature of 1,000 to 1,500° C. for 5 to 30 hours.

The pulverizing may utilize a conventional method such as ball milling, and a powder comprising a bimetal-doped barium cobaltite-based perovskite compound can be prepared through a process of mixing the sintered green compact with ethanol and then ball milling of the mixture.

Meanwhile, the bi-directional protonic ceramic fuel cell according to an embodiment may have a structure comprising a cathode prepared by the cathode material comprising the above bimetal-doped barium cobaltite-based perovskite, a proton conductive electrolyte layer located on the cathode, and an anode located on the proton conductive electrolyte layer.

The bi-directional protonic ceramic fuel cell with the above structure comprises the cathode prepared using barium the cobaltite-based perovskite doped with bimetals of scandium (Sc) and tantalum (Ta), and has improved electrical properties and long-term stability.

Specifically, the bi-directional protonic ceramic fuel cell can exhibit excellent electrical characteristics such as a power density of 0.27 to 1.97 W/cm² in fuel cell mode at 450 to 650° C. and a current density of 0.12 to 2.69 A/cm² in electrolytic cell mode at 450 to 650° C.

In particular, the bi-directional protonic ceramic fuel cell may comprise a barium cobaltite-based perovskite compound in which scandium (Sc) and tantalum (Ta) are each doped in equal amounts. In this case, as a result of evaluating the performance of the fuel cell mode and electrolytic cell mode, the fuel cell mode and electrolytic cell mode showed high performance at 1.36 W/cm² and 1.82 A/cm², respectively, at 600° C. In addition, as a result of evaluating long-term stability at 550° C., the performance of the cathode was maintained without change for more than 100 hours in fuel cell mode and 300 hours in electrolytic cell mode, showing excellent long-term stability.

In this case, the bi-directional protonic ceramic fuel cell may be an anode-supported bi-directional protonic ceramic fuel cell comprising a fuel functional layer and a fuel support layer.

The cathode material comprising the bimetal-doped barium cobaltite-based perovskite according to the above-described embodiment comprises the barium cobaltite-based perovskite structure compound in which the bimetal including scandium (Sc) and tantalum (Ta) is doped, showing high performance and long-term stability in fuel cell mode and electrolytic cell mode. Therefore, the cathode material can be very useful as a cathode material for bi-directional protonic ceramic fuel cells.

Hereinafter, the present disclosure will be described in more detail through Examples.

The presented Examples are only specific examples of the present disclosure and are not intended to limit the technical scope of the present disclosure.

### EXAMPLE

The bimetal-doped barium cobaltite-based perovskite (BaScₓTa_{0.2-x}Co_{0.8}O_{3-δ}) powder was prepared with the composition shown in Table 1 below (where x=0.05, 0.1, 0.15, each being BSTC05, BSTC10, BSTC15).

TABLE 1

| | |
|---|---|
| BSTC05 | BaSc_{0.05}Ta_{0.15}Co_{0.8}O_{3-δ} |
| BSTC10 | BaSc_{0.1}Ta_{0.1}Co_{0.8}O_{3-δ} |
| BSTC15 | BaSc_{0.15}Ta_{0.05}Co_{0.8}O_{3-δ} |

Specifically, the bimetal-doped barium cobaltite-based perovskite (BaScₓTa_{0.2-x}Co_{0.8}O_{3-δ}) powder was prepared by a solid state reaction method. First, barium carbonate (BaCO₃, Alfa Aesar), scandium oxide (Sc₂O₃, Alfa Aesar), tantalum oxide (Ta₂O₅, Alfa Aesar), and cobalt oxide (Co₃O₄, Sigma Aldrich) each were mixed in a stoichiometric ratio and ball milled with zirconia balls and ethanol for 24 hours to prepare a mixed pulverized product.

The prepared mixed pulverized product was pelletized and then sintered at 1200° C.for 20 hours. The sintered powder was crushed using a mortar and pestle, and then additionally pulverized through a ball-milling process using ethanol as a solvent to obtain perovskite powders (BSTC05, BSTC10, and BSTC15).

### Experimental Example

### (1) Unit Cell Preparation

Using tape casting and screen printing techniques, a anode-support layer, a fuel functional layer, an electrolyte layer, and a cathode layer that constitute a unit cell were sequentially laminated.

In this case, the slurry of the anode-support layer and fuel functional layer contained a complex of nickel oxide (NiO) and zirconium cesium yttrium ytterbium oxide (BaZrCeYYbO₃, BZCYYb). The electrolyte slurry was composed of barium zirconium cesium yttrium ytterbium oxide (BaZrCeYYbO₃, BZCYYb).

The prepared slurry was prepared into a tape through a tape casting process, and then the anode-support layer, fuel functional layer, and electrolyte tape were sequentially laminated and pressed at 110° C. The compressed tape was heat treated at 900° C. for 3 hours to remove organic substances remaining in each layer. Next, the pressed product from which organic substances were removed was sintered at 1,400° C. for 5 minutes using a microwave sintering furnace. After completing sintering, the cathode slurry was coated on the top of the electrolyte layer using a screen printing technique, dried, and sintered at 850° C. for 3 minutes using a microwave sintering furnace to prepare the final unit cell.

### (2) Cystal Structure Analysis

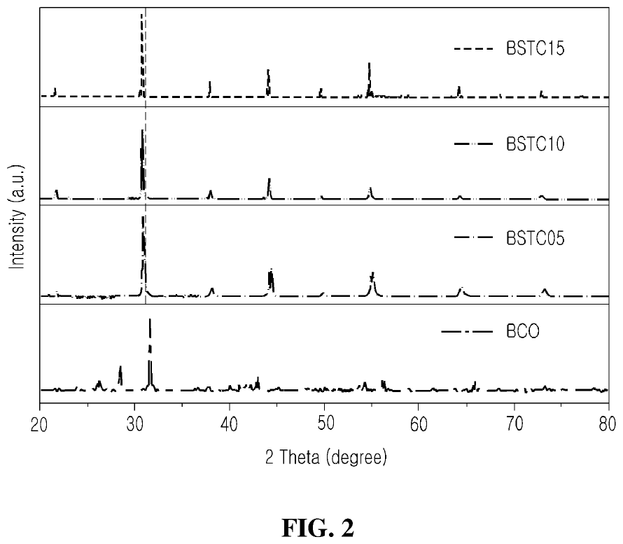

Powder XRD measurement was performed by crystal structure analysis using an X-ray diffraction analyzer (RIGAKU, SmartLab) in the 2θ range from 20 to 80° with Cu Kα radiation (λ=1.5418 Å). The result was shown in FIG. 2. In this case, the crystal structure was analyzed with barium cobaltite (BaCoO_{3-δ}, BCO) as a control. The crystal structure of the powder was refined using HighScore software.

FIG. 2 shows the results of analyzing an X-ray diffraction pattern to analyze the crystal structure of perovskite powders (BSTC05, BSTC10, BSTC15) prepared by a method according to Example.

As shown in FIG. 2, when barium cobaltite (BaCoO_{3-δ}, BCO) was doped with scandium and tantalum, respectively, it was confirmed that a cubic perovskite phase was formed. In this case, the lattice constant value was confirmed to be 4.091 Å for BSTC05, 4.100 Å for BSTC10, and 4.115 Å for BSTC15. Thus, it was confirmed that the lattice constant value increased as the doping concentration of scandium (Sc, 81 pm), which has a larger ionic radius than tantalum (Ta, 73 pm), increased.

### (3) Microstructure Analysis

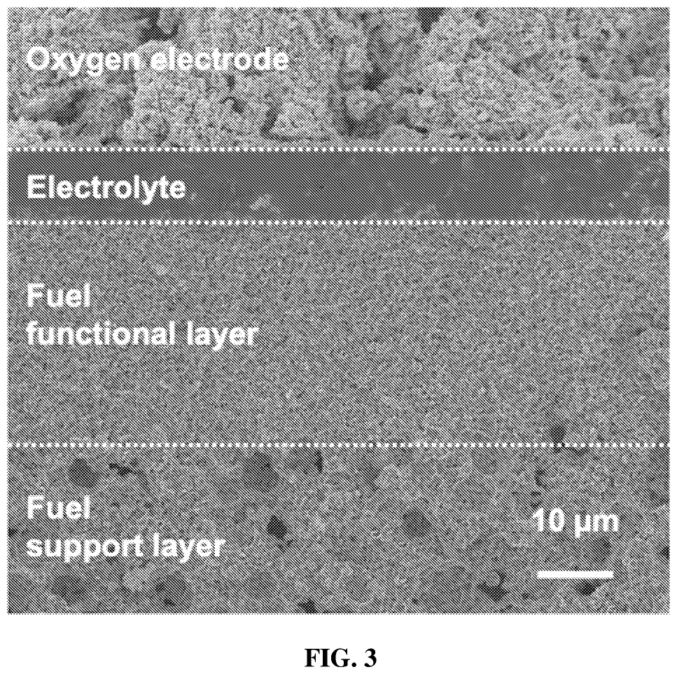

Microstructure analysis of the unit cell was performed using a scanning electron microscope (SEM, Hitachi SU8230), and the results were shown in FIG. 3.

FIG. 3 is an SEM image showing a microstructure of a cell with anode-supported bi-directional proton conduction unit, which comprises a cathode using a perovskite powder (BSTC10) manufactured by a method according to Example.

As shown in FIG. 3, the overall configuration of the unit cell comprises a fuel electrode comprising a cathode (oxygen electrode), an electrolyte, and an anode (fuel electrode) including a fuel functional layer and a fuel support layer. It was confirmed that the electrolyte had a thickness of 10 μm and a dense structure, and the oxygen electrode and electrolyte were well bonded without peeling.

### (4) Evaluation of Electrochemical Properties

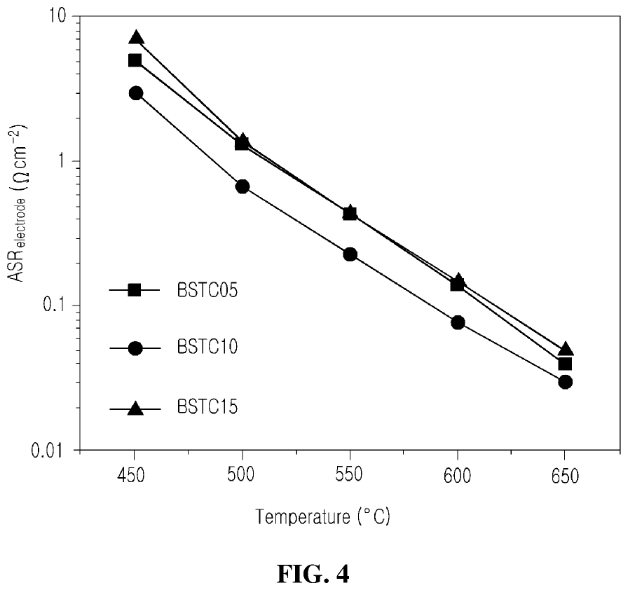

Electrochemical characteristics of the unit cell were evaluated using a potentiostat (Bio-Logic, VMP-300). During the evaluation, hydrogen (3% wet) and air (3% wet) were injected into the anode and cathode, respectively. The electrochemical characteristics of the unit cell were evaluated, and the results were shown in FIG. 4.

FIG. 4 shows the result of analyzing an electrode resistance of a cell with anode-supported bi-directional proton conductive unit, which comprises the cathode using perovskite powder (BSTC05, BSTC10, BSTC15) manufactured by a method according to Example.

As shown in FIG. 4, it can be confirmed that the electrode resistance of the unit cell comprising the cathode manufactured using the perovskite powder (BSTC10) in which scandium (Sc) and tantalum (Ta) are equally doped is the lowest.

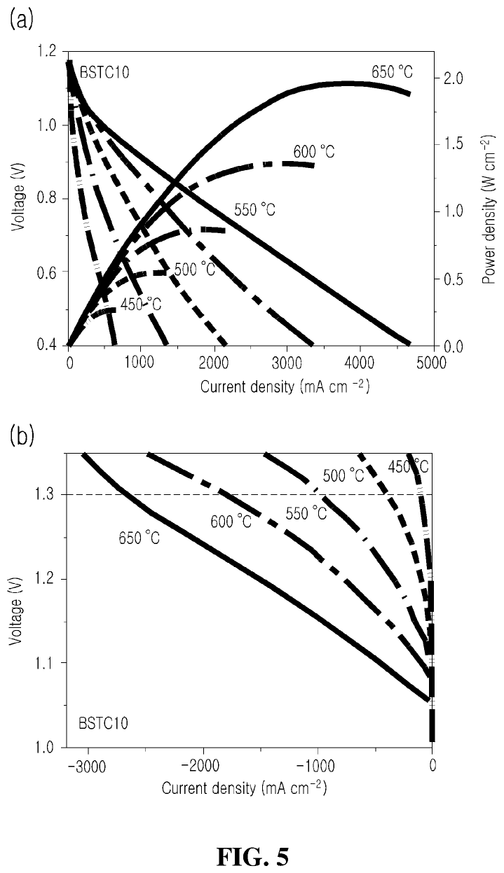

Accordingly, the performance of a unit cell comprising the cathode manufactured using the perovskite powder (BSTC10) in which scandium (Sc) and tantalum (Ta) are equally doped was evaluated in fuel cell mode and electrolytic cell mode. The results are shown in FIG. 5.

FIG. 5 shows the result of evaluating a performance in (a) fuel cell mode and (b) electrolytic cell mode of a cell with anode-supported bi-directional proton conductive unit, which comprises the cathode using the perovskite powder (BSTC10) manufactured by a method according to Example.

As shown in FIG. 5, it was confirmed that the corresponding unit cells exhibited the performances of 1.97 W/cm², 1.36 W/cm², 0.86 W/cm², 0.54 W/cm², and 0.27 W/cm², respectively, in fuel cell mode, and 2.69 A/cm², 1.82 A/cm², 0.97 A/cm², 0.41 A/cm², and 0.12 A/cm², respectively, in electrolytic cell mode, at 650° C., 600° C., 550° C., 500° C., and 450° C.

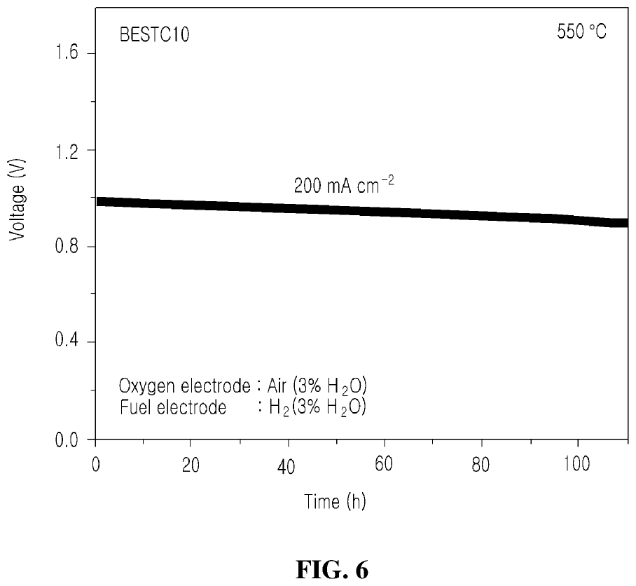

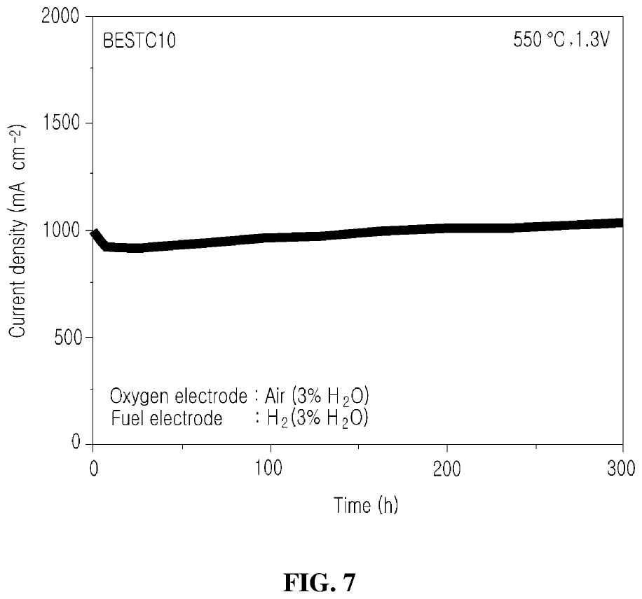

In addition, the long-term stability of the unit cell comprising the cathode manufactured using the perovskite powder (BSTC10) in which scandium (Sc) and tantalum (Ta) were equally doped was evaluated, and the results were shown in FIGS. 6 and 7, respectively.

FIG. 6 shows the result of evaluating a long-term stability in fuel cell mode of a cell with anode-supported bi-directional proton conductive unit, which comprises the cathode using the perovskite powder (BSTC10) manufactured by a method according to Example.

As shown in FIG. 6, it was confirmed that a fuel cell comprising the cathode manufactured using the perovskite powder (BSTC10) manufactured by the method according to Example was able to maintain its performance for more than 100 hours without significant decrease in performance when 200 mA/cm² was applied at 550° C. Thus, it was confirmed that the fuel cell exhibited excellent long-term stability.

FIG. 7 shows the result of evaluating a long-term stability in electrolytic cell mode of a cell with anode-supported bidirectional proton conductive unit, which comprises the cathode using the perovskite powder (BSTC10) manufactured by a method according to Example.

As shown in FIG. 7, it was confirmed that the current density of the fuel cell comprising the cathode manufactured using the perovskite powder (BSTC10) manufactured by the method according to Example was not decreased when the current density was measured for 300 hours at a temperature of 550° C. and 1.3 V. Thus, it was confirmed that the fuel cell exhibited excellent long-term stability.

Through the results described above, it was confirmed that all bimetal-doped barium cobaltite-based materials according to Example had a cubic perovskite crystal structure.

In addition, as a result of evaluating the electrochemical properties of the unit cell for the cathode manufactured using the bimetal-doped barium cobaltite-based material, it was confirmed that the barium cobaltite-based material in which scandium and tantalum were equally doped had the best electrical properties. As a result of evaluating the performance of the unit cell using the cathode with the corresponding composition in fuel cell mode and electrolytic cell mode, it was confirmed that the unit cell had high performance of 1.36 W/cm² and 1.82 A/cm², respectively, at 600° C.

In addition, as a result of evaluating long-term stability at 550° C., it was confirmed that performance was maintained without change for more than 100 hours in fuel cell mode and 300 hours in electrolytic cell mode.

Therefore, the bimetal-doped barium cobaltite-based perovskite (BaScₓTa_{0.2-x}Co_{0.8}O_{3-δ}) material according to Example shows high performance and long-term stability in fuel cell mode and electrolytic cell mode. Thus, it has been proven that the material is very promising as the cathode material for the bi-directional protonic ceramic fuel cell.

The cathode material according to Example produced by the present invention described above comprises a compound with the bimetal-doped barium cobaltite-based perovskite structure in which the bimetal including scandium (Sc) and tantalum (Ta) is doped. Thus, the material exhibits high performance and long-term stability in fuel cell mode and electrolytic cell mode, and can be very useful as the cathode material for a bi-directional protonic ceramic fuel cell.

The effects of the present disclosure are not limited to the above-mentioned effects, and it should be understood that the effects of the present disclosure include all effects that could be inferred from the configuration of the invention described in the detailed description of the invention or the appended claims.

Even though the above explained technical spirits of the present invention are specifically described in the preferred embodiments, it is important to note that the above embodiments are just for explanation, not for a limitation on the invention. Also, it will be apparent that one having ordinary skill in the art can make various modifications and changes thereto within the scope of the present invention. Therefore, the true scope of the present invention should be defined by the technical spirits of the appended claims.

1. A cathode material comprising a bimetal-doped barium cobaltite-based perovskite in which barium cobaltite is doped with scandium (Sc) and tantalum (Ta) and which is represented by following Formula 1:
BaScₓTa_{0.2-x}Co_{0.8}O_{3-δ} [Formula 1]
where X is 0.001<X<0.199, δ is 0<δ<2.

2. The cathode material of claim 1, wherein in the Formula 1, X is 0.05≤X≤0.15.

3. The cathode material of claim 1, wherein the bimetal-doped barium cobaltite-based perovskite has a cubic perovskite crystal structure at room temperature.

4. A method for manufacturing a cathode material comprising:
mixing a barium precursor, a scandium precursor, a tantalum precursor, and a cobalt precursor respectively and ball milling the mixture to prepare a mixed pulverized product;
pelletizing the mixed pulverized product to prepare a green compact; and
sintering and pulverizing the green compact to prepare a bimetal-doped barium cobaltite-based perovskite powder in which barium cobaltite is doped with scandium (Sc) and tantalum (Ta) and which is represented by following Formula 1:
BaScₓTa_{0.2-x}Co_{0.8}O_{3-δ} [Formula 1]
where X is 0.001<X<0.199, δ is 0<δ<2.

5. The method of claim 4, wherein in preparing the bimetal-doped barium cobaltite-based perovskite powder, the mixed pulverized product is sintered at a temperature of 1,000 to 1,500° C.

6. A bi-directional protonic ceramic fuel cell, comprising:
a cathode prepared by the cathode material of claim 1;
a proton conductive electrolyte layer located on the cathode; and
an anode located on the proton conductive electrolyte layer.

7. The bi-directional protonic ceramic fuel cell of claim 6, wherein the bi-directional protonic ceramic fuel cell has a power density of 0.27 to 1.97 W/cm² in fuel cell mode at 450 to 650° C., and a power density of 0.12 to 2.69 A/cm² in electrolytic cell mode at 450 to 650° C.

8. The bi-directional protonic ceramic fuel cell of claim 6, wherein in the bi-directional protonic ceramic fuel cell. a performance of the cathode does not change for more than 100 hours in fuel cell mode at 550° C. and for more than 300 hours in electrolytic cell mode at 550° C.
